(19) United States
(12) Patent Application Publication
(10) Pub. No.: US 2016/0263494 A1
(43) Pub. Date: Sep. 15, 2016

(54) METHOD AND APPARATUS FOR TREATMENT OF OIL BASED DRILLING FLUID

(71) Applicants: M-I L.L.C., Houston, TX (US); M-I Drilling Fluids UK Ltd., Scotland (GB)

(72) Inventors: Frank Manfred Franz Mueller, Houston, TX (US); Martin Hunter, Hamilton (GB)

(21) Appl. No.: 15/044,012

(22) Filed: Feb. 15, 2016

Related U.S. Application Data
(60) Provisional application No. 62/116,161, filed on Feb. 13, 2015.

(51) Int. Cl. B01D 17/04; C02F 1/40; C02F 1/52; C02F 1/44; C02F 1/24; B01D 61/02; C02F 1/38; B01D 17/02; B01D 21/01; B01D 21/00; B01D 21/26; B01D 61/14; C02F 1/54; C02F 1/463

(52) U.S. Cl. CPC B01D 17/047; C02F 1/547; C02F 1/40; C02F 1/52; C02F 1/444; C02F 1/24; C02F 1/463; C02F 1/441; C02F 1/38; B01D 17/0214; B01D 21/01; B01D 21/0084; B01D 21/262; B01D 61/145; B01D 61/025; B01D 21/0009; C02F 2103/10

(57) ABSTRACT

A system may include a tank storing slop water and an in-line mixing device in communication with the tank to contact a stream of slop water from the tank, an emulsion breaker. The system may further include an emulsion breaker source to inject emulsion breaker into the stream of slop water; and a two-phase separator in communication with the in-line mixing device, the separator to separate the slop water into a mud phase and a water phase.

The present application claims the benefit of U.S. Provisional Application No. 62/116,161 filed on Feb. 13, 2015, incorporated by reference herein in its entirety.

### BACKGROUND

Oil-based drilling fluids or oil-based mud (OBM) are generally used in the form of invert emulsions. Invert emulsion fluids, i.e., emulsions in which the non-oleaginous fluid is the discontinuous phase and the oleaginous fluid is the continuous phase, are employed in the drilling processes for the development of oil or gas sources, as well as, in geothermal drilling, water drilling, geological survey drilling and mine drilling. Specifically, the invert emulsion fluids are conventionally utilized for such purposes as providing stability to the drilled hole, forming a thin filter cake, lubricating the drilling bore and the downhole area and assembly, and penetrating salt beds without sloughing or enlargement of the drilled hole.

Slop water is a waste stream which is produced when oil based drilling fluids become contaminated with water or when water based solutions are contaminated with oil. This can be a by-product of cleaning the drill floor, shaker room, pump room or cleaning the rig, boat or mud plant tanks.

Slop water treatment methods may be based on breaking the slop emulsion, separating and recovering the oil based mud and water phases and treatment of the water phase by flocculation and filtration. Such water treatment methods may occur as batch treatment processes, in-line processes, or other processes in certain desired situations.

### BRIEF DESCRIPTION OF THE DRAWINGS

These and other aspects are better understood when the following detailed description is read with reference to the accompanying drawings, in which:

FIG. 1 is an example embodiment of a drilling fluid processing system; and

FIG. 2 is an example embodiment of a slop separation section of the drilling fluid processing system in FIG. 1.

### DETAILED DESCRIPTION

The method and apparatus discussed herein may enhance the recycling of slop water into oil-based/synthetic oil-based drilling mud (e.g., invert emulsion fluids) and clean water. The clean water extracted during this process should be of high enough purity to meet the local regulatory limits for allowing discharge from the rig. The present disclosure may reduce the transportation of fluid waste in boat tanks to shore, which in turn may (1) reduce the risk of spills; (2) reduce the need for supply boat tank cleaning and with this cost and time; (3) reduce the need for offshore transport and, with this, a reduction in CO₂ production; (4) reduce the risk of a possible halting of drilling operations due to unfavorable weather conditions which prevent a supply boat from docking at a drilling rig coupled with the existing storage capacities on the rig being exhausted; (5) reduce the need of the supply of new drilling mud due to losses; and, (6) will reduce the need for special waste disposal onshore. Further, methods and/or apparatus discussed herein may create the possibility of utilizing other means of sequential water treatment such as ultra-filtration, dissolved air floatation, reverse osmosis, electro-coagulation and other continuous flow water treatment.

The components of the invert emulsion fluids utilized in the method of the present invention generally include an oil liquid such as hydrocarbon oil which serves as a continuous phase, an aqueous liquid such as water or brine solution which serves as a discontinuous phase, and an emulsifying agent. As used herein, emulsifying agent and surfactant can be used interchangeably to describe the surface active agents used to create the inverse emulsion drilling fluid. The emulsifying agent serves to lower the interfacial tension of the liquids so that the aqueous liquid may form a stable dispersion of fine droplets in the oil liquid. The invert emulsion fluids of the present invention are useful in a similar manner as conventional invert emulsion fluids which includes utility in preparation for drilling, drilling, completing and working over subterranean wells such as oil and gas wells.

As used herein the term or “oleaginous liquid” of the oil-based mud (OBM) may refer to an oil which is a liquid at 25° C. and immiscible with water. Oleaginous liquids typically include substances such as diesel oil, mineral oil, synthetic oil, ester oils, glycerides of fatty acids, aliphatic esters, aliphatic ethers, aliphatic acetals, or other such hydrocarbons and combinations of these fluids. The amount of oleaginous fluid in the invert emulsion fluid may vary depending upon the particular oil fluid used, the particular aqueous fluid used, and the particular application in which the invert emulsion fluid is to be employed. However, generally the amount of oil liquid must be sufficient to form a stable emulsion when utilized as the continuous phase.

As used herein, the term “aqueous liquid” means any substance which is a liquid at 25° C. and which is not an oleaginous fluid as defined above. Aqueous liquids are immiscible with oil liquids but capable of forming emulsions therewith. Typical aqueous liquids include aqueous substances such as fresh water, sea water, brine containing inorganic or organic dissolved salts, aqueous solutions containing water-miscible organic compounds and mixtures of these. In one illustrative embodiment the aqueous fluid is brine solution including inorganic salts such as calcium halide salts, zinc halide salts, alkali metal halide salts and the like.

The method of preparing the drilling fluids for use in the present disclosure is not particularly critical so long as an invert emulsion is formed. Generally, the components may be mixed together in any order under agitation condition in an emulsion breaking tank, for example, as described below. A representative method of preparing said invert emulsion fluids comprises mixing an appropriate quantity of oil fluid and an appropriate quantity of surfactant together with continuous, mild agitation. An aqueous fluid is then added while mixing until an invert emulsion is formed. If weight material, such as those described below, are to be added, then the weight material is typically added after the invert emulsion fluid is formed.

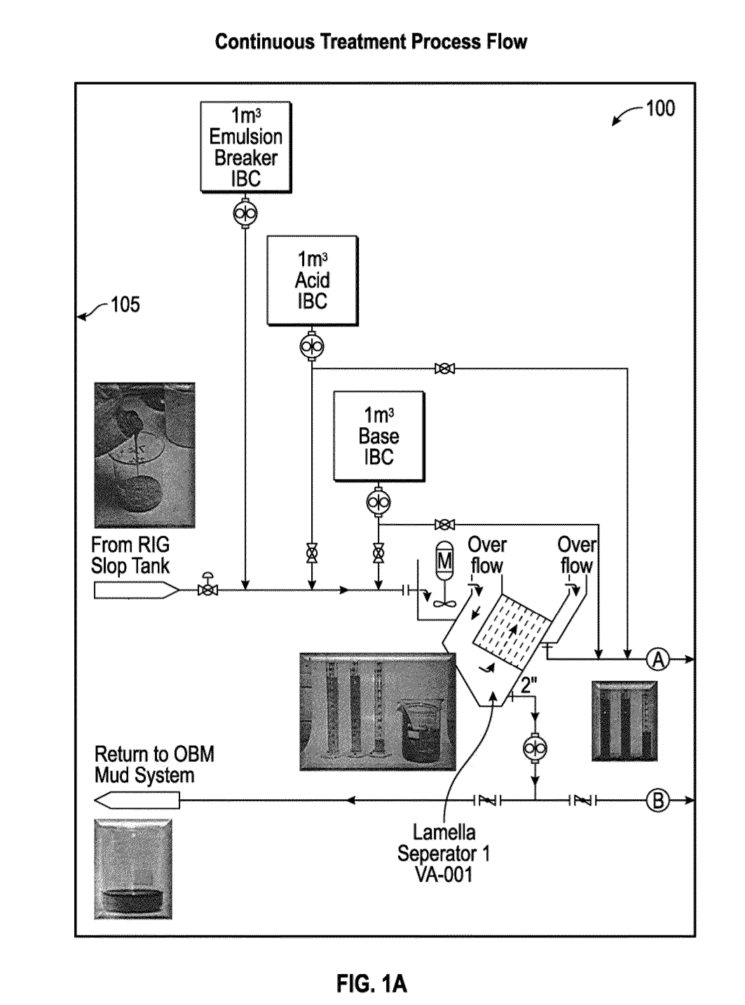

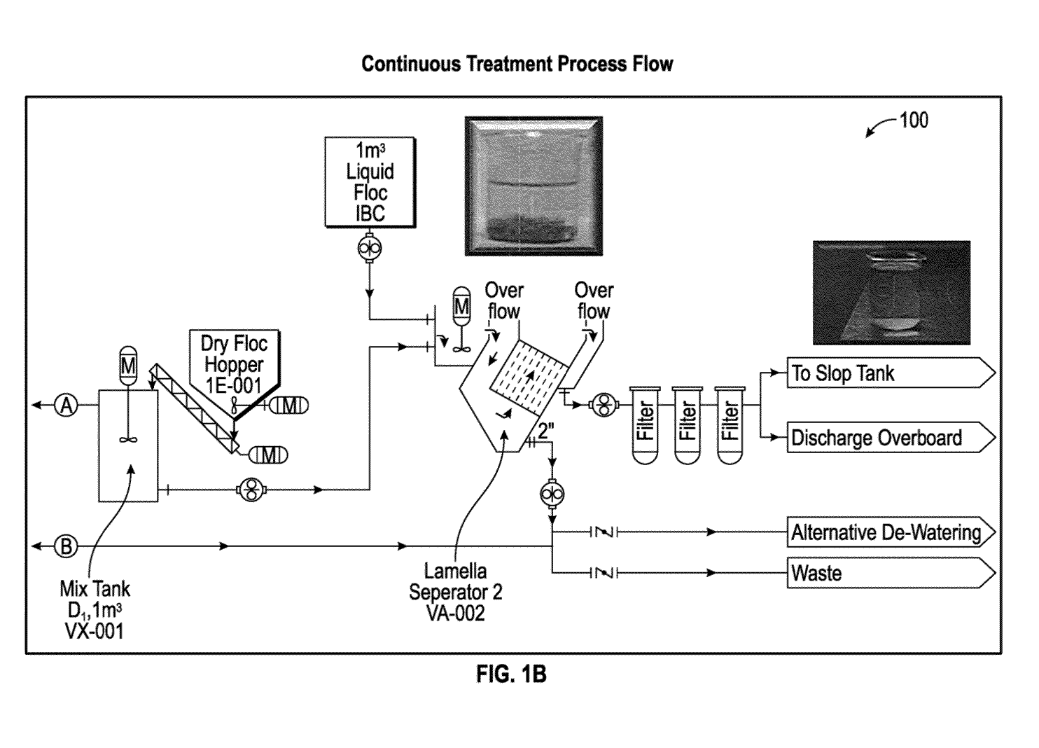

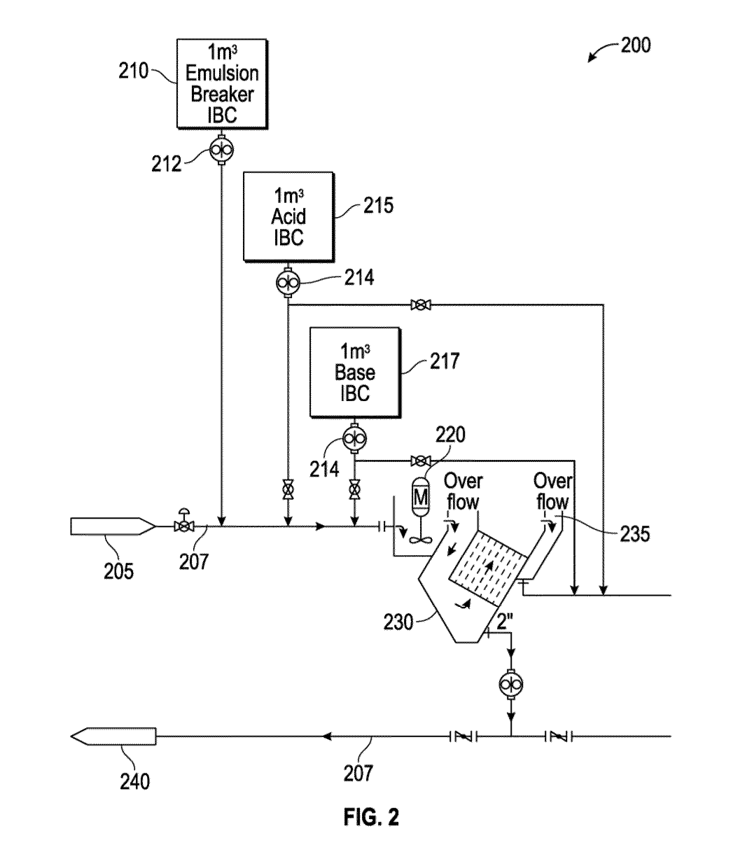

Referring now to FIG. 1, a fluid processing system 100 is generally provided. The system shown in the FIG. 1 may be a drilling fluid recycling system, such as a mobile system. The system 100 may include a slop separation section 200 which is shown in more detail in FIG. 2.

Referring now to FIG. 2, the slop separation section 200 may generally include a slop water tank 205, an emulsion breaker tank 210, a pH adjuster 215, a flocculent tank 217, an in-line mixer 220, or a separator 225, singly or in combination. Slop from the slop tank 205 may be sent via a line 207 to an emulsion breaker tank 210 to be in contact with an emulsion breaker via a distributor 212 during stirring. Emulsion breakers (not shown), also referred to as tension breakers, may comprise tensids, such as non-ionic and anionic tensids, anionic or non-ionic surfactants, alkyl polyglycoside, or combinations thereof, as mere examples. Further, any agent or compound that removes water from the slop may be used as an emulsion breaker.

The emulsion breaker may be continuously dosed at concentrations of approximately 0.1-5% v/v with a dosing pump. The amount of emulsion breaker to start with will be predetermined by testing a manually obtained sample from rig slop tank. The emulsion breaker can be directly injected into the slop stream and may involve no pre-dilution.

The line 207 may be in contact with at least one pH adjuster tank 215 or flocculent tank 217 whereby the slop is subjected to chemicals, via nozzles 214, to modify its pH, flocculents (e.g., bentonite-based flocculents, etc.) and/or coagulants, such as to eliminate/minimize hydrocarbon, organic, or heavy metal contamination as well as accelerate separation of the aqueous component of slop into an organic phase and a clarified water phase. Upon addition of such chemicals, the slop may agitated by an in-line mixer 220. For example, slop within line 207 may be vigorously agitated while bentonite based flocculent is added via a nozzle (not shown) into a water treatment tank (not shown). A typical dose of flocculent may be between 2 and 4 kilograms per cubic meter of waste water.

The usual contaminants in the waste or slop water may be hydrocarbons, general organics, and heavy metals. After the bentonite has been wetted, the agitation speed may be reduced and the water and bentonite solution is mixed until large, stable bentonite flocculates loaded with the contaminants from the water are observed. The agitation is stopped, and the flocculates are allowed to settle to the bottom of the treatment tank.

As shown in FIG. 2, the mixture of the emulsion breaker and the slop water may be moved to a two-phase separator 230 where the mixture is separated by gravity into a dense mud phase which is primarily oil based mud and a lighter water phase which is primarily oily water. The residence time for this reaction may take approximately 15 minutes. In one possible embodiment, the two-phase separator may a lamella clarifier.

The two-phase separator, such as a lamella clarifier, may comprise at least one inclined plate, each providing a substantially effective settling area relative to the surface area of each plate. The at least one plate may be an angle less than 90° relative to the plane of the fluid line 207. The inlet stream of slop water is stilled upon entry into the separator, with mud and other solid particles settling on the plates, which accumulate to the bottom portion of the separator, while the lighter liquid portion rises to the top portion of the separator. Eventually, the water phase may separate from the separator into a receptacle 235, such as one designated for overflow water or liquid materials.

The water phase or oily water will be treated with any water treatment system such as ultra-filtration, reverse osmosis, dissolved air floatation, or any other or combination of water treatment systems. A disc stack centrifuge may also be used for water treatment system.

The mud phase or OBM sludge may be collected in the solids collection section (not shown) of the two-phase separator 230 and removed automatically from the separator via a discharge pump (not shown). By methods herein, the invert emulsion may stay intact, the oil remaining with the mud, once processed by the two-phase separator. The level may be controlled by a density vibronic level indicator or other appropriate equipment. Thereafter, the OBM stream is measured and returned back via the line 207 to the mud system 240 of the drilling rig for reuse. The mud phase out of the two-phase separator 230 may have an oil to water ratio of 60 to 40 or higher.

Such system may consist of at least one module, in various configurations such as separate modules, skid mounted or contained modules, which can be mobile and/or placed on a drilling rig's deck surface. For systems comprising at least two modules, a first module may separate the bulk part of the water fraction under use of a chemical reaction from the oil based/synthetic base drilling mud. The oil based mud/synthetic oil based mud may be transferred back to the shaker house of the rig where it is treated on the rig shaker and directed back into the active mud system. The extracted water may be pumped into a second module where it will be treated with a flocculent, such as a bentonite based flocculent, for example, to eliminate/minimize hydrocarbon, organic and/or heavy metal contamination. The produced treatment sludge (contaminate loaded bentonite flocculent) may be directed to a filter press for de-watering and solidification for transport and disposal. The cleaned water phase may be pumped over an integrated filter package, which will additionally eliminate hydrocarbon contamination. A check may be performed to confirm that the water is within regulator limits prior to being discharged.

The methods and apparatus discussed herein provides the following functions: 1) break oil based slop emulsion through the application of mixing energy, mechanical/non-mechanical separation and surfactant chemistry, 2) separate dense mud phase and water phase from oil based slop water, 3) enhance oil/water ratio of the separated oil based drilling fluid by extracting water thereby returning the chemical composition of the oil based drilling fluid to a recyclable state and 4) release the separated water to a water treatment system with acceptable levels of solids to prevent upsetting the water treatment system. Moreover, the process rate for treating the contaminated slop may be around 10 m³/hr or higher using the method and apparatus discussed herein because the addition of the emulsion breaker to the oil based mud and mixing of the two can be conducted in a continuous and automated manner.

The present disclosure also represents methods and apparatus for separating contaminated slop water from the oleaginous portion of invert emulsion drilling fluids or muds using the above described apparatus with a mixer in-line with a two-phase separator, so as to reduce the need for batch processing of fluids. This method allows the fluids or muds to be recycled for reuse in the drilling of subterranean wells at the well itself whereby a continuous line provides a pathway for a fluid from a rig through a processing system, then back to the fluid system or rig, without disruption to the flow of the fluid.

Although the preceding description has been described herein with reference to particular means, materials, and embodiments, it is not intended to be limited to the particulars disclosed herein; rather, it extends to all functionally equivalent structures, methods, and uses, such as are within the scope of the appended claims.

What is claimed:

1. A method comprising:
forming a mixture of an emulsion breaker and slop water;
separating the mixture into a mud phase and a water phase, wherein the separating utilizes a lamella clarifier;
moving the mud phase to a rig for reuse; and
moving the water phase to a water treatment section.

2. The method of claim 1, wherein the method is conducted in an automated manner.

3. The method of claim 1, wherein the forming comprises mixing the emulsion breaker and the slop water using an in-line mixer.

4. The method of claim 1, wherein the mud phase has an oil to water ratio of 60 to 40 or higher.

5. The method of claim 1, wherein the water treatment section treats the water phase using flocculation and coagulation.

6. The method of claim 1, wherein the water treatment section treats the water phase using ultra-filtration. The method of claim 1, wherein the water treatment section treats the water phase using dissolved air flotation.

8. The method of claim 1, wherein the water treatment section treats the water phase using electro-coagulation.

9. The method of claim 1, wherein the water treatment section treats the water phase using reverse osmosis.

10. The method of claim 1, wherein the water treatment section comprises a disc stack centrifuge.

11. A system comprising:
a tank storing slop water;
an in-line mixing device in communication with the tank to contact a stream of slop water from the tank;
an emulsion breaker source to inject emulsion breaker into the stream of slop water; and
a two-phase separator in communication with the in-line mixing device, the separator to separate the slop water into a mud phase and a water phase.

12. The system of claim 11, wherein the two-phase separator is a lamella clarifier comprising at least one inclined plate.

13. The system of claim 11, wherein the two-phase separator is in communication with a drilling fluid tank to which the mud phase is moved.

14. The system of claim 11, further comprising a water treatment section in communication with the separator, wherein the water treatment section treats the water phase using flocculation and coagulation.

15. The system of claim 11, wherein the water treatment section treats the water phase using ultra-filtration.

16. The system of claim 11, wherein the water treatment section treats the water phase using dissolved air floatation.

17. The system of claim 11, wherein the water treatment section treats the water phase using electro-coagulation.

18. The system of claim 11, wherein the water treatment section treats the water phase using reverse osmosis.

19. The system of claim 11, wherein the water treatment section comprises a disc stack centrifuge.

20. The system of claim 11 comprising a line for carrying the slop water, wherein the line is in communication with the tank storing the slop water, the in-line mixing device, the emulsion breaker source and the two-phase separator.
